(19) United States
(12) Patent Application Publication
(10) Pub. No.: US 2005/0201684 A1
(43) Pub. Date: Sep. 15, 2005

(54) Conductive electrode structure for an electro-optic material

(76) Inventors: Christopher P. Yakymyshyn, Seminole, FL (US); William Q. Law, Beaverton, OR (US); William A. Hagerup, Portland, OR (US)

Correspondence Address: WILLIAM K. BUCHER;TEKTRONIX, INC., P O BOX 500 (50-LAW), BEAVERTON, OR, 97077-0001, US

(21) Appl. No.: 11/077,649

(22) Filed: Mar. 10, 2005

Related U.S. Application Data
(60) Provisional application No. 60/552,334, filed on Mar. 10, 2004.

(51) Int. Cl. G02F 1/035

(52) U.S. Cl. 385/40

(57) ABSTRACT

An electrode structure for electro-optic material used in optical cavities is described. The electrode structure has first and second apertures disposed generally parallel to an optical signal propagating within the electro-optic material. Electrically conductive material is disposed within the apertures coupling an electrical signal to the electro-optic material.

### CROSS-REFERENCE TO RELATED APPLICATION

This application claims the benefit of the U.S. Provisional Application No. 60/552,334, filed Mar. 10, 2004.

### BACKGROUND OF THE INVENTION

The present invention relates generally to electro-optic materials and more particularly to conductive electrode structure for electro-optic materials providing increased sensitivity to applied electrical fields.

Electro-optic material is a class of inorganic and organic crystals where the index of refraction of the material changes in response to electromagnetic energy applied to the material. Such material may be used in the production of optical devices, such as optical switches, optical limiters, optical modulators and the like. In it simplest form, an optical signal, such as the output of a laser or the like, is launched into the electro-optic material having length and widths in the millimeter range and thicknesses in the tenths of millimeter range. The diameter of the optical path of the optical signal within the electro-optic material generally ranges from ten to a few hundreds microns across. Electrodes are formed on opposing surfaces of the electro-optic material that are parallel to the optical path of the signal passing through the electro-optic material. An electrical signal is applied to the electrodes which varies the index of refraction of the electro-optic material as a function of the variations of the electrical signal. The variations of the index of refraction of the electro-optic material alters the optical signal propagating through the electro-optic material.

The strength of the electric field distribution within the electro-optic material is a function of the distance between the opposing electrodes and the amplitude of the applied electrical signal. The strength of the electric field is the inverse of the distance separation of the electrodes. As the distance between the electrodes decreases, the strength of the electric field between them increases. As the distance decreases, the magnitude of the electrical signal can decrease to generate the same amount of change in the index of refraction.

Currently, the minimum overall dimensions of the electro-optic material used in optical devices and cavities is limited by the practical size at which the material can be handled resulting in electrodes that are positioned at a substantial distance from the optical path of the optical signal. This results in optical devices having low sensitivity to the applied electrical signal.

U.S. Pat. No. 5,353,262 describes an ultrasound optical transducer that generates an optical signal the frequency of which varies in correspondence with acoustic energy incident on the transducer. The transducer includes a housing in which is disposed a signal laser. The signal laser is preferably a microchip laser, microcavity laser or the like. The signal laser has an optical cavity disposed between first and second reflectors and in which a lazing medium (also known as a gain crystal) is disposed. The reflectors are disposed on opposing plane-parallel surfaces of the lasing medium. An optical source injects an optical signal at a first frequency into the signal laser, which generates a second output signal at a second frequency. Acoustic energy impinging on the transducer causes the index of refraction of the optical cavity to change which in turn, causes the frequency of the signal laser to change. The frequency modulated optical signal from the signal laser is coupled to signal processing assembly that generates an output signal corresponding to the amplitude of the incident acoustic energy for use in imaging and analysis. An alternative embodiment is described where a piezoelectric device is positioned on the transducer for converting the acoustic energy into an electrical signal. The electrical signal is applied to electrodes on the signal laser. The electrical signal causes a change in the index of refraction of the optical cavity as a function of the acoustic energy applied to the piezoelectric device.

U.S. Pat. No. 4,196,396 describes the use of a Fabry-Perot enhanced electro-optic modulator to produce a bistable resonator that could be used as an optical switch, optical limiter, or optical memory device. A further embodiment taught by the '396 patent is an optical amplifier. The reference teaches the use of high voltage signals in the thousand voltage range to change the index of refraction of the electro-optic material in the Fabry-Perot cavity.

U.S. Pat. No. 5,394,098 describes the use of longitudinal Pockels effect in an electro-optic sensor for in-circuit testing of hybrids and circuits assembled on circuit boards. In one embodiment, a layer of electro-optic material is disposed between opposing layers of optically reflective materials that include electrically conductive layers. The optically reflective layer having highest reflectivity to an applied optical signal is placed in contact with a conductor on the circuit board. The other optically reflective layer is coupled to electrical ground. An optical signal from a laser is applied orthogonal to the optically reflective layers on the electro-optic material. An electrical signal on the conductor of the circuit board produces a voltage potential difference across the optically reflective layers which varies the refractive index of the electro-optic material. A drawback to this design is that the orientation of the polarized optical signal is orthogonal to the orientation of the electromagnetic field producing the Pockels effect in the electro-optic material. This reduces the sensitivity of the measured electrical signal. Further, forming electrically conductive layers on the opposing sides of the electro-optic material produces capacitive and inductive effects in the electro-optic sensor that limits the useful bandwidth of the system.

What is needed is an electrode structure for electro-optic materials and that improves the sensitivity of the electro-optic materials.

### SUMMARY OF THE INVENTION

Accordingly, the present invention is directed to an electrode structure for electro-optic materials having first and second apertures formed in the electro-optic material on opposing sides and generally parallel to a received optical signal propagating within the electro-optic material. Electrically conductive material is disposed within the first and second apertures. The first and second apertures are preferably disposed adjacent to the optical path of the optical signal propagating within the electro-optic material. Respective electrically conductive contacts may be formed on an exterior surface of the electro-optic material with one of the contacts electrically coupled to the electrically conductive material disposed in the first aperture and the other contact electrically coupled to the electrically conductive material disposed in the second aperture. A termination resistor may be electrically coupled across the respective electrically conductive contacts coupled to the electrically conductive material disposed in the first and second apertures. The termination resistor may also be electrically coupled across the electrically conductive material disposed in the first and second apertures.

The electro-optic material preferably has X, Y, and Z optical axes and the received optical signal propagates generally parallel to one of the optical axes and first and second apertures are generally parallel to same optical axis. The propagation path of the optical signal and the first and second apertures lay on a plane defined by the optical axis parallel to the propagation path of the optical signal and the first and second apertures and one of the other two optical axes. The electro-optic material may be a Y-cut or X-cut crystal with the first and second apertures respectively parallel to the Y optical axis or the X optical axis. The X, Y and Z optical axes of the electro-optic material may be mutually perpendicular to each other or have one or more optical axes at oblique angles to each other.

The objects, advantages and novel features of the present invention are apparent from the following detailed description when read in conjunction with appended claims and attached drawings.

### BRIEF DESCRIPTION OF THE DRAWINGS

FIGS. 1A-1C illustrate alternative electrode configurations of the electrode structure for electro-optic materials according to the present invention.

FIGS. 2A-2E illustrate alternative contact configurations in the electrode structure for electro-optic materials according to the present invention.

FIGS. 3A-3B illustrate the use of a termination resistor in the electrode structure for electro-optic materials according to the present invention.

### DETAILED DESCRIPTION OF THE PREFERRED EMBODIMENT

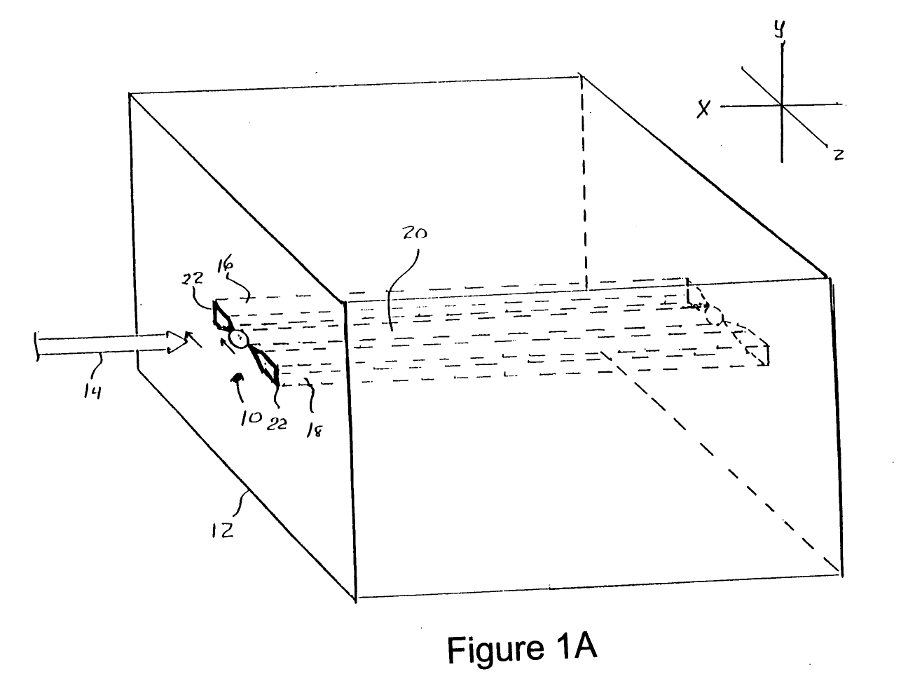

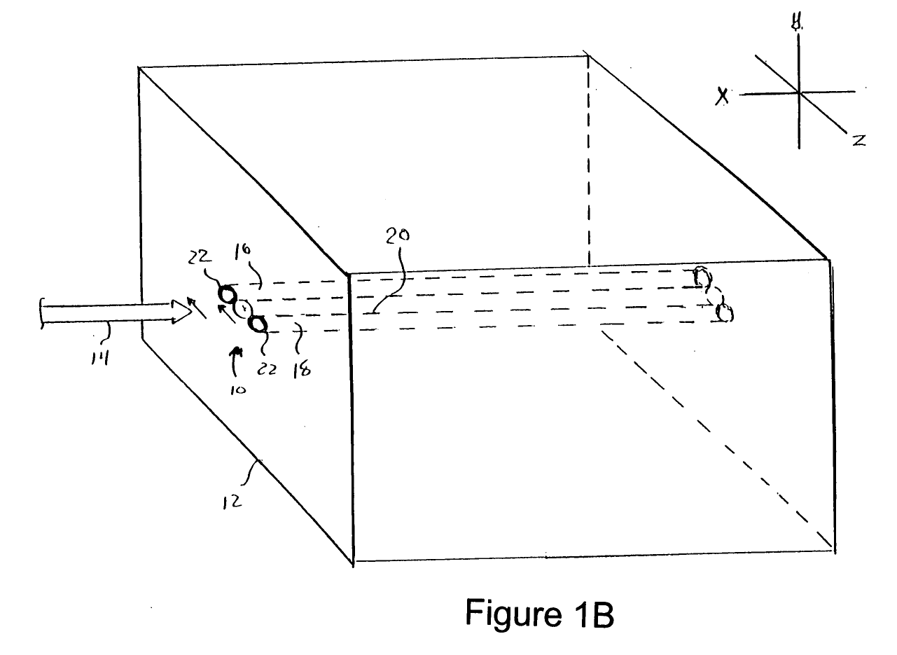

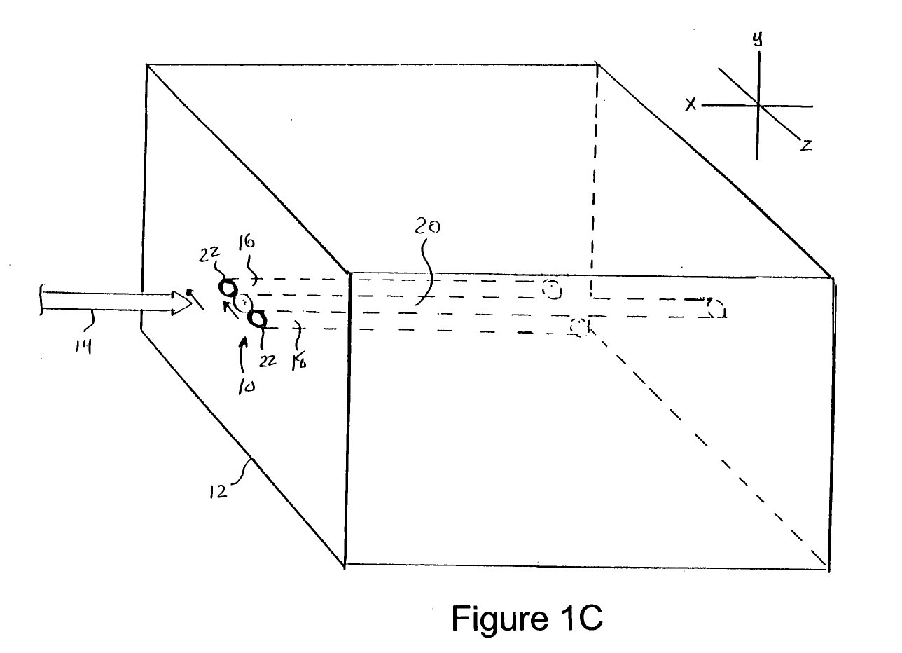

Referring to FIGS. 1A, 1B and 1C, there are shown various electrodes structures 10 usable in electro-optic material 12 receiving an optical signal 14. The electro-optic material 12 may be formed from inorganic and organic materials, such as Potassium Titanyl Phosphate (KTP), Rubidium Titanyl Arsenate (RTA), Rubidium Titanyl Phosphate (RTP), Zinc Telluride (ZnTe), DimethylAmino-methyl Stilbazolium Tosylate (DAST) or other electro-optic materials, such as electro-optic polymers, all having the property of a changing index of refraction in response to an applied electro-magnetic field. The inorganic and organic materials have crystallographic axes defining the crystallographic structure of the electro-optic material 12. Crystals systems are cubic, tetragonal, orthorhombic, monoclinic and triclinic. The crystallographic axes for the cubic, tetragonal and the orthorhombic systems are mutually perpendicular to each other. The monoclinic and triclinic crystal systems have one or more of the crystallographic axes at oblique angles to each other. The hexagonal crystal system has two crystallographic axes falling on the same plane at 120° to each other and a third axis orthogonal to the other two. The inorganic and organic materials further have X, Y and Z optical axes which may or may not coincide with the crystallographic axes.

The electrode structure 10 for electro-optic materials will be described below in relation to inorganic KTP electro-optic material having an orthorhombic crystalline structure and optical axes coincident with the crystallographic axes. It is understood that the electrode structure 10 of the present invention is applicable to the other crystal structures and organic polymers having one or more optical axes that are responsive to an electromagnetic field for changing the index of refraction of the electro-optic material 12. Further, the present invention will be described in relation to specific optical axes of the KTP electro-optic material 12 and a specific orientation of a propagating optical signal 14 and orientations of the electro-magnetic field within the KTP electro-optic material 12. In the preferred embodiment, the KTP electro-optic material 12 is an X-cut crystal face where the cleaved and polished surfaces of the crystal are perpendicular to the optical X-axis. Alternatively, the KTP electro-optic material 12 may be a Y-cut crystal face. The X-cut crystal is preferred over the Y-cut crystal for minimizing distortions from the acoustic modes generated within the electro-optic material 12. It should be noted that the electro-optic properties of other crystallographic structures may result in the preferred cut crystal face being orthogonal to the optical Z-axis producing a Z-cut crystal face.

The optical signal 14 provided to the electro-optic material 12 is preferably provided by a coherent optical source, such as a laser diode or the like. The optical signal 14 is polarized as either linear or circular polarized light. The optical signal preferably passes through bulk optic lenses to provide a generally collimated or focused beam onto the electro-optic material 12. An example of a generally collimated optical signal 14 focused on an electro-optic material is a 1310 nm optical signal having an optical path diameter ranging from approximately 15 to 150 microns. Other optical path diameters may be used with the electrode structure 10 of the present invention. The linear or circular polarization states of the optical signal 14 are normal to the propagation direction of the signal. The change in the index of refraction of the electro-optic material 16 in the presence of an electromagnetic field is a function of the orientation of the optical signal propagating in the electro-optic material 12 and the relationship of the polarization state of the optical signal 14 and the electrode structures 10 to the optical axes of the electro-optic material 12. For example, KTP electro-optic material exhibits the highest index of refraction and largest sensitivity response to an electromagnetic signal when the polarization state of the optical signal 14 and the electro-magnetic field are parallel with the optical Z-axis of the KTP material. However, the KTP electro-optic material exhibits the highest piezoelectric response along the Z-axis, and the lowest piezoelectric response along the X-axis, when the electromagnetic field is parallel to the optical Z-axis. The piezoelectric effect causes a change in the refractive index of the crystal, but also physically alters the length of the material (or strain) along the three principle crystal axes. To minimize the effect of the piezoelectric strain on the modulated signal, it is desirable to ensure that the smallest change in crystal length occurs along the crystal axis that is perpendicular to the two cavity mirrors attached to the crystal. Therefore, in the preferred embodiment, the polarization state of the optical signal 14 and the electromagnetic field are parallel with the optical Z-axis, and the optical beam propagates through the crystal parallel to the X-axis to minimize the effects of the acoustic modes in the KTP electro-optic material on the resulting optical modulation.

The electrode structures 10 in FIGS. 1A, 1B and 1C have a pair of apertures 16 and 18 formed in the KTP electro-optic material 12 that are generally parallel to the optical path 20 of the received optical signal 14 propagating through the electro-optic material 12. The KTP electro-optic material 12 has mutually perpendicular optical axes X, Y and Z that coincide with the crystallographic axes of the KTP material. The apertures 16 and 18 are disposed on the opposite sides of the optical path 20 of the propagating optical signal and are oriented parallel to the optical X-axis of the electro-optic material 12. The apertures 16 and 18 are preferably formed as close as possible to the propagating optical signal with the aperture separation, for example, being in the range of 45 to 120 microns. In some applications, the apertures 16 and 18 may extend into the optical path 20 of the propagating optical signal 14. The apertures 16 and 18 in FIG. 1A have a polygonal sectional shape with an apex directed toward the optical path 20 of the propagating optical signal 14. The apexes of the polygonal shapes concentrates the electromagnetic field across the optical path 20, which is parallel to the optical Z-axis of the electro-optic material. The polygonal electrode structure does not lend itself to usual manufacturing processes whereas a circular electrode structure as illustrated in FIG. 1B is easily produced. The circular apertures 16 and 18 in FIG. 1B have the same orientation with the optical path 20 as in FIG. 1A. The circular apertures 16 and 18 are produced using an excimer pulsed laser that can produce apertures of approximately 100 microns in diameter and of varying depth in the electro-optic material 12. The circular apertures 16 and 18 in FIG. 1C are shown extending part way through the electro-optic material 12 and have the same orientation with the optical path 20 in FIG. 1B. The blind hole apertures reduce the risk of damage to the electro-optic material 12 when the pulsed laser light from the excimer laser reaches the opposite end of the electro-optic material 12. The aperture configurations of FIGS. 1A-1C are but three examples and other aperture configurations are possible without departing from the scope of the invention.

Electrically conductive material 22 is disposed within each of the apertures 16 and 18. The electrically conductive material 22 may take the form of conductive wires shaped to conform to the apertures 16 and 18, conductive material deposited on the inner surfaces of the apertures, conductive epoxy filling the apertures, or the like. The deposited conductive material 22 is preferably gold plated over a layer of chromium. The electrically conductive material 22 preferably extends to the exterior surface of the electro-optic material 12 to allow the electrode structure 10 to be electrically coupled to an electromagnetic source, such as a voltage source. Alternately, the electrically conductive material 22 may be connecting terminals for the voltage source where the ends of the terminals are inserted into the apertures 16 and 18. In a further alternative, the electrically conductive material 22 may reside totally within the electro-optic material 12 and the connecting terminals are inserted into the apertures to make contact with the electrically conductive material 22. Forming the electrode structure 10 within the electro-optic material 12 decreases the distance between the electrodes thus increasing the strength of the electric field applied across optical path 20 of the propagating optical signal 14. This increases the sensitivity of the electro-optic material 12 to the applied electric field.

In a specific embodiment where the electrically conductive material 22 is an electrically conductive epoxy, the apertures 16 and 18 extend through the electro-optic material 12 and the electrically conductive epoxy fills the apertures 16 and 18. Filter paper is positioned on one side of the electro-optic material 12 covering the apertures 16 and 18. A vacuum is applied to this side of the electro-optic material 12 and the electrically conductive epoxy is applied to the apertures 16 and 18 on the other side of the electro-optic material 12. The vacuum causes the electrically conductive epoxy to be drawn into the apertures 16 and 18. The filter paper prevents the electrically conductive epoxy from being drawn out of the apertures 16 and 18.

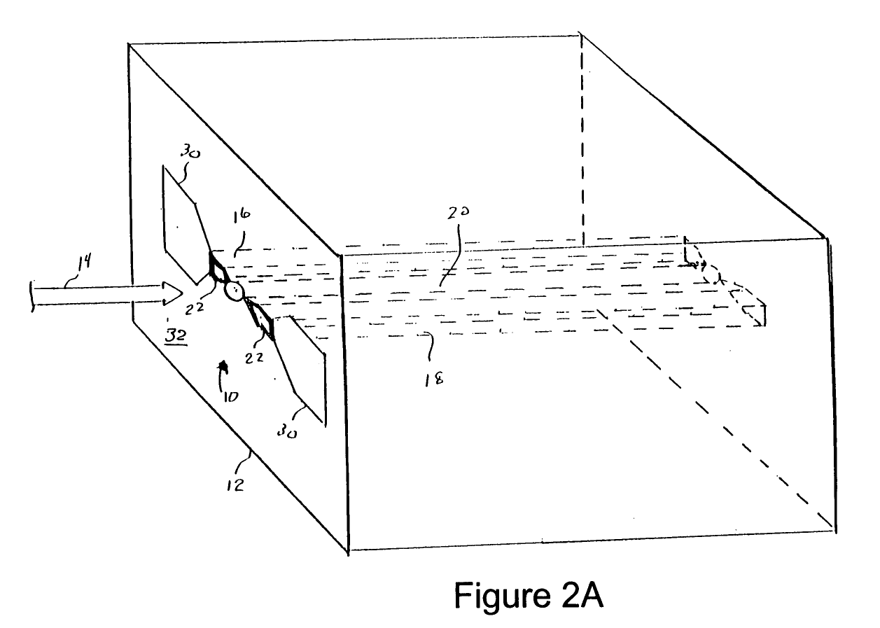

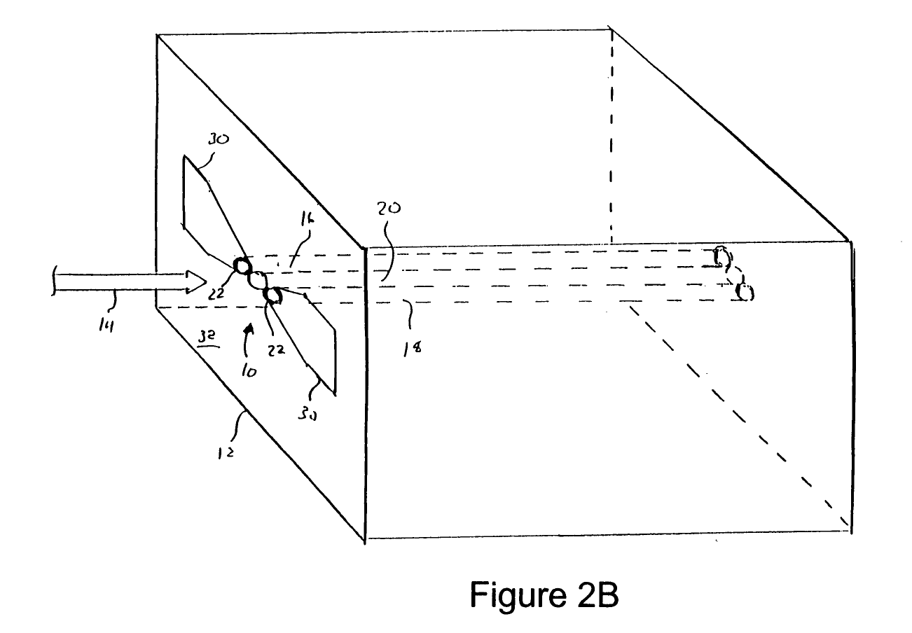

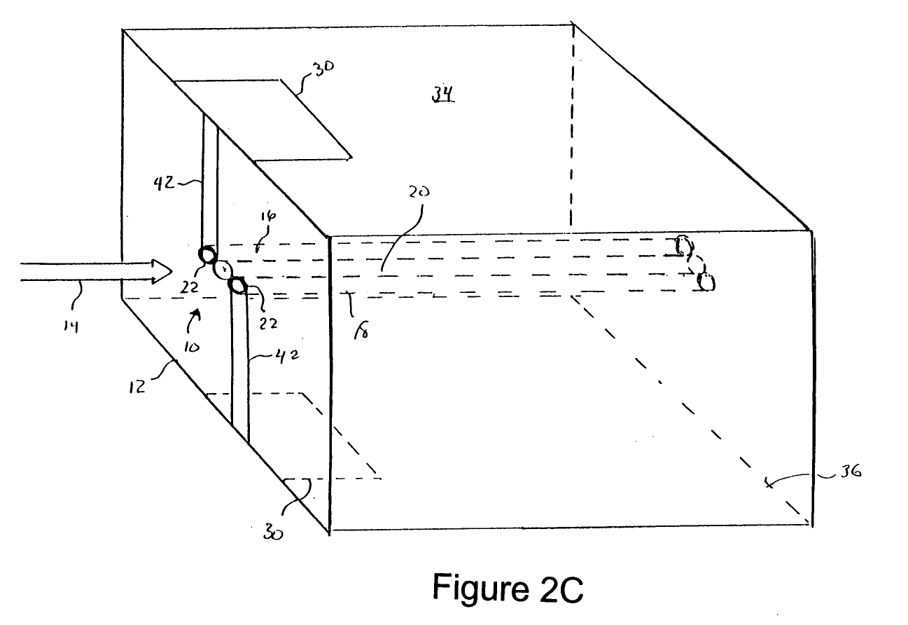

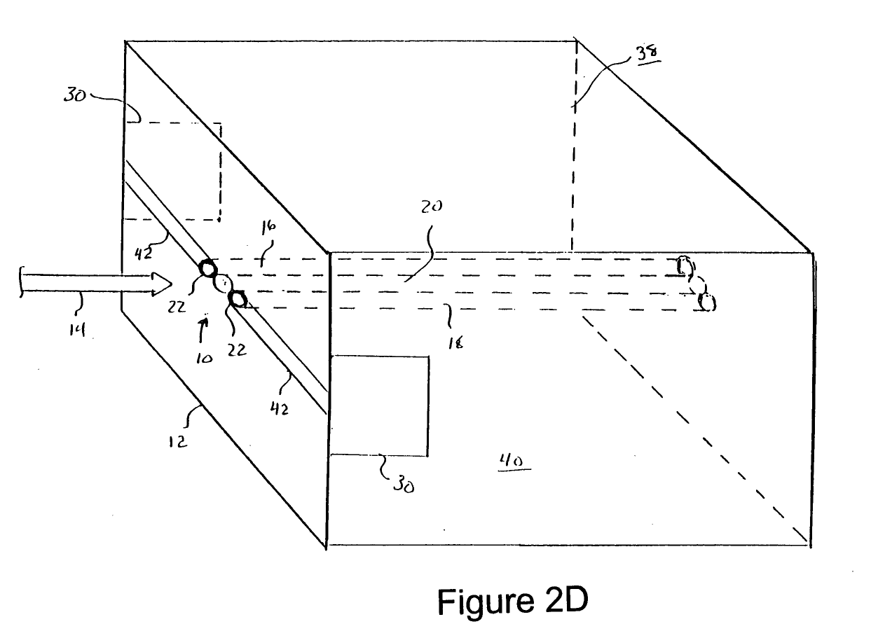

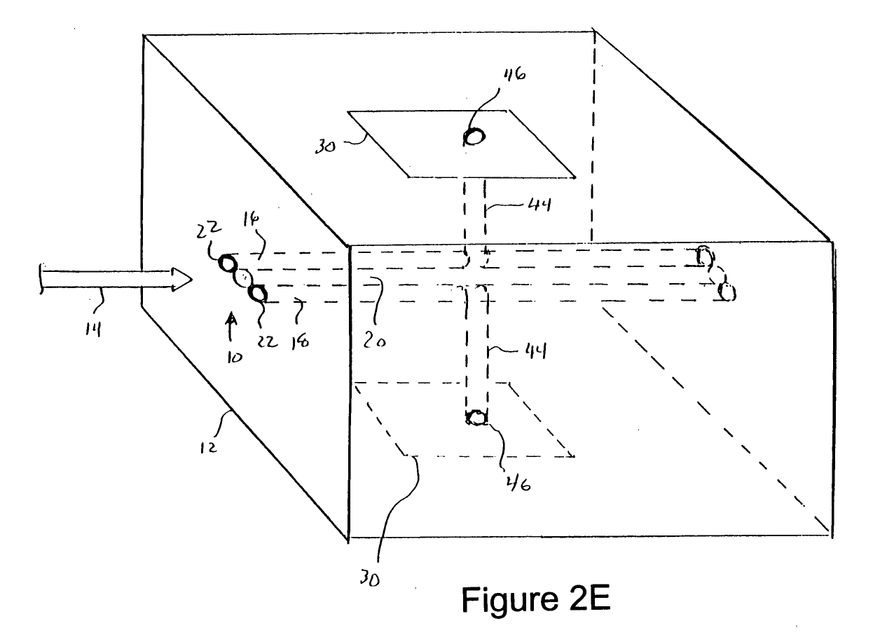

FIGS. 2A through 2E illustrates alternative electrically conductive contact 30 configurations in the electrode structure 10 of the present invention. The electrically conductive contacts 30 may be formed using well know deposition techniques, such as thin and thick film processes. The electrically conductive contacts 30 are preferably formed of gold deposited over a layer of chromium. In FIGS. 2A and 2B, the electrically conductive contacts 30 are formed on the same exterior surface 32 of the electro-optic material 12 with each contact 30 in electrical contact with the electrically conductive material 22 in one of the respective apertures 16 and 18. The electrically conductive contacts 30 are preferably a polygonal shape with an apex electrically coupled to the respective electrically conductive materials 22 in the apertures 16 and 18. In the preferred embodiment, the separation between the electrically conductive contacts 30 is in the range of 15 to 100 microns with the apertures 16 and 18 set slightly back from the apexes of the contacts 30. In FIGS. 2C and 2D, the electrically conductive contacts 30 are formed on opposing exterior surfaces 34, 36 and 38, 40 of the electro-optic material 12. Conductive traces 42 electrically couple the electrically conductive material 22 of the respective apertures 16 and 18 to the electrically conductive contacts 30 on the opposing surfaces 34, 36 and 38 and 40. While the figures illustrate the electrically conductive contacts 30 being on opposing surfaces of the electro-optic material 12, the electrically conductive contacts 30 may be formed on adjacent surfaces of the electro-optic material 12. As with the electrically conductive contacts 30 formed on the same surface, the apertures 16 and 18 intersect the conductive traces 42 with the separation between the conductive traces at the apertures 16 and 18 being in the range of 15 to 100 microns. FIG. 2E illustrates a further configuration for the electrically conductive contacts 30. Apertures 44 are formed in the electro-optic material 12 that intersect the respective electrode structure apertures 16 and 18. Electrically conductive contacts 30 are formed on the surface or surfaces of the electro-optic material that intersect the apertures 44. Electrically conductive material 46 is disposed in the apertures 44 that electrically couples the electrically conductive contacts 30 to the electrically conductive material 22 in the apertures 16 and 18.

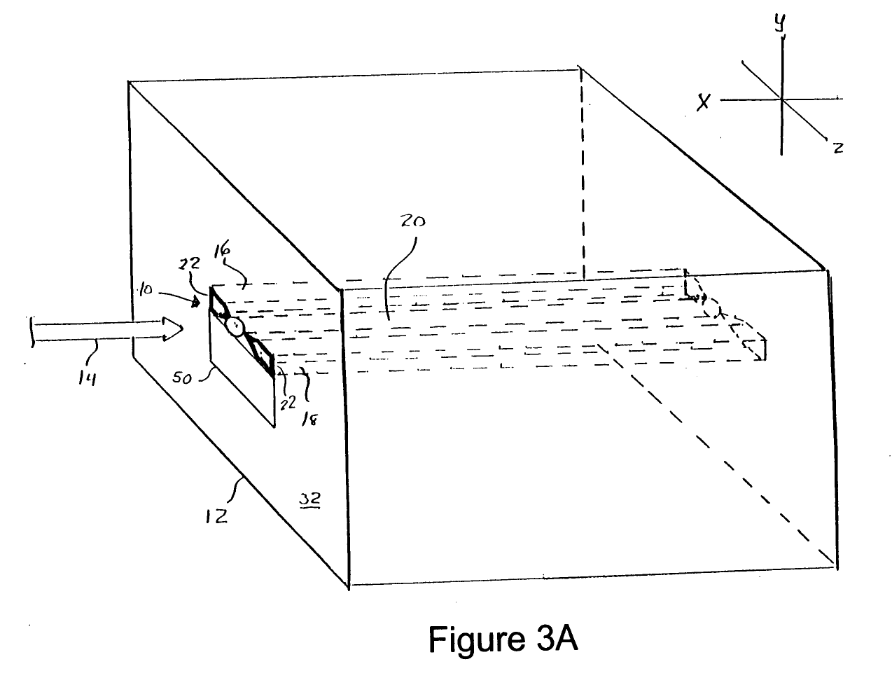

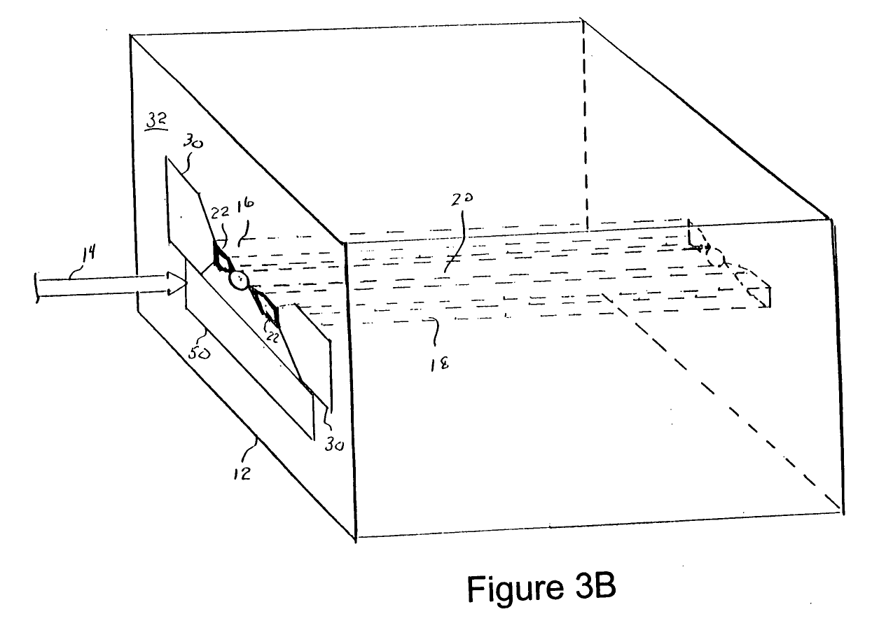

Referring to FIGS. 3A and 3B, there are shown further embodiments of the electrode structure for an electro-optic material. The electrode structure described has an high input impedance. In certain applications it may be preferable to match the impedance of the electrode structure to the impedance of the device driving the electro-optic material. In FIG. 3A, an optional termination resistor 50 is shown formed on exterior surface 32 of the electro-optic material 12 that is perpendicular to the apertures 16 and 18. The termination resistor 50 is connected between the electrically conductive materials 22 in the apertures 16 and 18 of the electro-optic material 12. The termination resistor 50 may be formed using well known processing techniques, such as thin or thick film processing. The resistance of the termination resistor 50 is set to match the impedance of the device driving the electro-optical material 12. The termination resistor 50 may also be formed on exterior surface 52 of the electro-optic material 12 where the apertures are formed as through holes in the electro-optic material. In FIG. 3B, the optional termination resistor 50 is shown connected between the electrically conductive contacts 30 on the exterior surface 32 of the electro-optic material 12. In the embodiments where conductive traces 42 couple the electrically conductive contacts to the electrically conductive materials 22 in the apertures 16 and 18, the termination resistor 50 may be coupled to the conductive traces 42.

An electrode structure for electro-optic materials has been described having first and second apertures formed in the electro-optic material on opposing sides and generally parallel to a received optical signal propagating within the electro-optic material. Electrically conductive material is disposed within the first and second apertures. Electrically conductive contacts may be formed on an exterior surface of the electro-optic material with one of the contacts electrically coupled to the electrically conductive material disposed in the first aperture and the other contact electrically coupled to the electrically conductive material disposed in the second aperture. A termination resistor may be electrically coupled across the respective electrically conductive contacts coupled to the electrically conductive material disposed in the first and second apertures. The termination resistor may also be electrically coupled across the electrically conductive material disposed in the first and second apertures.

It will be obvious to those having skill in the art that many changes may be made to the details of the above-described embodiments of this invention without departing from the underlying principles thereof. The scope of the present invention should, therefore, be determined only by the following claims.

1. A conductive electrode structure for an electro-optic material receiving an optical signal comprising:
first and second apertures formed in the electro-optic material on opposing sides and generally parallel to the received optical signal propagating within the electro-optic material; and
electrically conductive material disposed within the first and second apertures.

2. The conductive electrode structure as recited in claim 1 further comprising a resistor coupled between the electrically conductive materials disposed within the first and second apertures.

3. The conductive electrode structure as recited in claim 1 further comprising electrically conductive contacts formed on at least a first exterior surface of the electro-optic material with one of the electrically conductive contacts electrically coupled to the electrically conductive material disposed in the first aperture and the other electrically conductive contact electrically coupled to the electrically conductive material disposed in the second aperture.

4. The conductive electrode structure as recited in claim 3 further comprising a resistor coupled between the electrically conductive contacts.

5. The conductive electrode structure as recited in claim 3 wherein each of the electrically conductive contacts is formed on a separate exterior surface of the electro-optic material.

6. The conductive electrode structure as recited in claim 1 wherein the first and second apertures are disposed adjacent to the received optical signal propagating through the electro-optic material.

7. The conductive electrode structure as recited in claim 1 wherein the received optical signal propagates generally parallel to at least a first optical axis in the electro-optic material with the first and second apertures generally parallel to same optical axis.

8. The conductive electrode structure as recited in claim 1 wherein the electro-optic material has X, Y, and Z optical axes and corresponding crystal faces orthogonal to the respective X, Y, and Z optical axes with the conductive electrode structure further comprising the first and second apertures being orthogonal to the Y-crystal face of the electro-optic material.

9. The conductive electrode structure as recited in claim 8 wherein the X, Y and Z optical axes are mutually perpendicular.

10. The conductive electrode structure as recited in claim 1 wherein the electro-optic material has X, Y, and Z optical axes and corresponding crystal faces orthogonal to the respective X, Y, and Z optical axes with the conductive electrode structure further comprising the first and second apertures being orthogonal to the X-crystal face of the electro-optic material.

11. The conductive electrode structure as recited in claim 10 wherein the X, Y and Z optical axes are mutually perpendicular.

12. The conductive electrode structure as recited in claim 1 wherein the electro-optic material has X, Y, and Z optical axes and corresponding crystal faces orthogonal to the respective X, Y, and Z optical axes with the conductive electrode structure further comprising the first and second apertures being orthogonal to the Z-crystal face of the electro-optic material.
